(19) United States
(12) Patent Application Publication
(10) Pub. No.: US 2014/0131093 A1
(43) Pub. Date: May 15, 2014

(54) WIRE HARNESS

(71) Applicant: SUMITOMO WIRING SYSTEMS, LTD., MIE (JP)

(72) Inventors: Takeshi SATO, Mie (JP); Isamu HAMAMOTO, Mie (JP); Tetsuya SONODA, Mie (JP); Tomohiro SHIMADA, Mie (JP)

(73) Assignee: SUMITOMO WIRING SYSTEMS, LTD., MIE (JP)

(21) Appl. No.: 14/044,052

(22) Filed: Oct. 2, 2013

(30) Foreign Application Priority Data
Nov. 15, 2012 (JP) 2012-250904

(51) Int. Cl. H01B 9/00

(52) U.S. Cl. CPC H01B 9/00
USPC 174/70 R

(57) ABSTRACT

An attachment orientation of a fixating member is stabilized, and the fixating member is able to be attached in an accurate position in a case where a non-woven member is hot pressed around a wire harness main body to form a protective member. The wire harness includes a wire harness main body and a protective member. The protective member is formed by hot pressing a non-woven member in a state where the non-woven member covers at least a portion of the wire harness main body. A flat support surface is formed on at least a portion of an outer circumference of the protective member and at least one positioning surface is formed so as to be adjacent to the flat support surface in a direction orthogonal to an axis direction of the wire harness main body and so as to project further than the flat support surface.

### CROSS-REFERENCE TO RELATED APPLICATIONS

The present application claims priority under 35 U.S.C. §119 of Japanese Application No. 2012-250904, filed on Nov. 15, 2012, the disclosure of which is expressly incorporated by reference herein in its entirety.

### BACKGROUND OF THE INVENTION

1. Field of the Invention

The present invention relates to a technology protecting a wire harness.

2. Description of Related Art

Japanese Patent Laid-open Publication No. 2012-110086 discloses a technology protecting a wire harness with a protective member formed by a non-woven member. The protective member is formed in a non-circular cross-sectional shape matching a location where the protective member will be placed. Therefore, flat portions are formed on the protective member depending on the shape of the location where the protective member will be placed.

A wire harness is often attached to a vehicle via a clamp.

Typically, a wire harness installed in a vehicle body is formed by bundling a plurality of electric wires, and therefore has a circular shape in cross-section. A protective member covering the wire harness is also formed so as to have a circular shape in cross-section, When the clamp is attached to the protective member having this circular shape in cross-section, the clamp may oscillate and shift around the protective member and an orientation thereof (a projection direction of the clamp) may become unstable.

When the clamp is attached to a flat outer circumferential portion of the protective member disclosed in Japanese Patent Laid-open Publication No. 2012-110086, the orientation of the clamp is stabilized to a certain degree.

However, in Japanese Patent Laid-open Publication No. 2012-110086, the flat outer circumferential portion is merely formed around the protective member and thus has an insufficient ability to fix a position of the clamp, In particular, the position of the clamp may become unstable in a direction orthogonal to an axis direction of the wire harness.

Thus, the present invention seeks to stabilize an attachment orientation of a fixating member and to enable the fixating member to be attached in an accurate position in a case where a non-woven member is hot pressed around a wire harness main body to form a protective member.

### SUMMARY OF THE INVENTION

In order to resolve the above issues, a wire harness according to one aspect includes a wire harness main body and a protective member, the protective member being formed by hot pressing a non-woven member in a state where the non-woven member covers at least a portion of the wire harness main body, the protective member having a flat support surface formed on at least a portion of an outer circumference and at least one positioning surface formed adjacent to the flat support surface in a direction orthogonal to an axis direction of the wire harness main body and rising in a direction projecting from the flat support surface.

Another aspect is the wire harness, wherein a fixating member including an attachment plate having a long, thin plate shape and a vehicle body fixation portion capable of fixating to a vehicle body is attached to the protective member in a state where the attachment plate is in surface contact with the flat support surface and at least one side of the attachment plate is in contact with the at least one positioning surface.

Another aspect is the wire harness, wherein a width of the flat support surface is set equal to or smaller than a width of the attachment plate, the attachment plate is attached to the protective member by being wound together with the protective member by a winding member, and a second side of the attachment plate is pressed by the winding member such that a first side of the attachment plate is pressed against the positioning surface.

Another aspect is the wire harness, wherein the at least one positioning surface includes a pair of the positioning surfaces provided on two sides of the flat support surface, and two sides of the attachment plate are in contact with the pair of positioning surfaces.

Another aspect is the wire harness, wherein at least one axis-direction positioning surface is formed on the protective member, the axis-direction positioning surface being adjacent to the flat support surface in the axis direction of the wire harness main body.

Accordingly, by attaching the fixating member to the flat support surface, the orientation of the fixating member can be stabilized. In addition, by pressing the fixating member against the positioning surface, the fixating member can be attached in a more accurate position in a direction orthogonal to the axis direction of the wire harness main body.

Accordingly, the orientation of the fixating member can be further stabilized and the fixating member can be attached in a more accurate position.

Accordingly, by pressing the second side of the attachment plate with the winding member, the first side of the attachment plate is pressed against the positioning surface, and thus the fixating member can be attached in a more accurate position in a direction orthogonal to the axis direction of the wire harness main body.

Accordingly, the two sides of the attachment plate are in contact with the pair of positioning surfaces, and thus the fixating member can be attached in a more accurate position in a direction orthogonal to the axis direction of the wire harness main body.

Accordingly, the fixating member can be attached in a more accurate position even in the axis direction of the wire harness main body.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic perspective view illustrating a wire harness according to an embodiment;

FIG. 2 is a schematic perspective view illustrating a fixating member;

FIG. 3 is schematic perspective view illustrating a state in which the fixating member is attached to a protective member;

FIG. 4 is a schematic cross-sectional view illustrating a state in which the fixating member is attached to the protective member; and

FIG. 5 is a schematic perspective view illustrating a state in which the fixating member is attached to a protective member according to a variant example.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

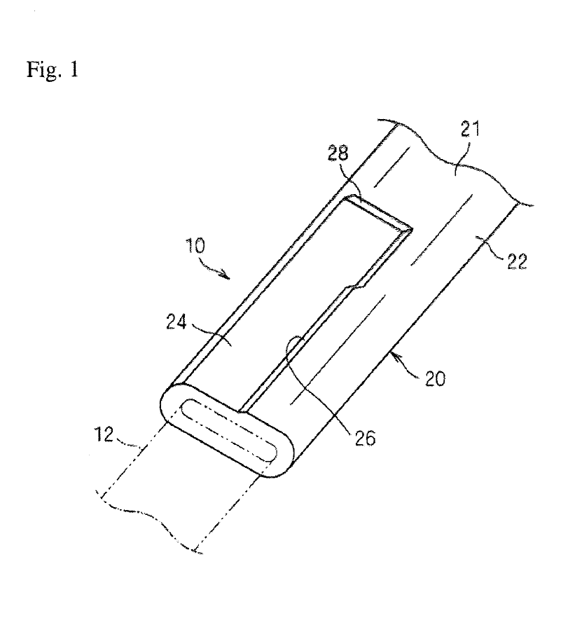

Hereafter, a wire harness according to an embodiment is described. FIG. 1 is a schematic perspective view illustrating a wire harness 10 according to the embodiment.

The wire harness 10 includes a wire harness main body 12 and a protective member 20.

The wire harness main body 12 includes at least one electric wire. Herein, the wire harness 12 is configured by bundling a plurality of electric wires along a wiring path of a vehicle body, which is where the wire harness main body 12 is to be placed. Moreover, the electric wires are a wiring material making a mutual electrical connection between various electric devices in the vehicle body and the like. The wire harness main body 12 may also include optical cables and the like.

The protective member 20 is formed by hot pressing a non-woven member (non-woven fabric, for example) in a state where the non-woven member covers at least a portion in a longitudinal direction of the wire harness main body 12. Moreover, the protective member 20 may cover approximately the entire longitudinal direction of the wire harness main body 12, and may cover a portion of the wire harness main body 12.

Anything capable of hardening when undergoing a heating process can be used as the non-woven member. As the non-woven member of this type, a non-woven member can be used that includes an elementary fiber and an adhesive resin (also referred to as a binder) interwoven therewith. The adhesive resin is a resin having a melting point lower than that of the elementary fiber (for example, 110° to 115° C.). When the non-woven member is heated at a treatment temperature lower than the melting point of the elementary fiber and higher than the melting point of the adhesive resin, the adhesive resin melts and seeps in between the elementary fibers. Thereafter, when the temperature of the non-woven member becomes lower than the melting point of the adhesive resin, the adhesive resin hardens in a state bonding the elementary fibers together. The non-woven fiber then becomes harder than in a state before heating and is maintained in a shape molded during the heating. In addition, the melted adhesive resin also seeps into and hardens at portions where non-woven members touch each other. Thereby, the touching portions of the non-woven members are joined.

However, the elementary fiber may be a fiber able to hold a fiber form at the melting point of the adhesive resin and various kinds of fibers can be used as the elementary fiber besides a resin fiber. In addition, a thermoplastic resin fiber having a melting point lower than the melting point of the elementary fiber can be used as the adhesive resin. The adhesive resin may have a granular shape or a fiber shape. The adhesive resin may also be configured as an adhesive resin layer formed on an outer circumference of a core fiber to configure a binder fiber and may be interwoven with the elementary fibers. The same material as that of the elementary fiber described above can be used as the core fiber in such a case.

Examples of a combination of the elementary fiber and the adhesive resin include using a PET (polyethylene terephthalate) resin fiber for the elementary fiber and a PET and PEI (polyethylene isophthalate) copolymer resin as the adhesive resin. In such a case, the melting point of the elementary fiber is approximately 250° C. and the melting point of the adhesive resin is 110° C. to 150° C. Therefore, when the non-woven member is heated to a temperature of 110° C. to 250° C., the adhesive resin melts and seeps in between the elementary fibers, which hold their fiber shape without melting. Then, when the temperature of the non-woven member becomes lower than the melting point of the adhesive resin, the adhesive resin hardens in a state bonding the elementary fibers together, maintaining the molded form and joining the non-woven members together,

Also, hot pressing refers to conducting a heating process on the non-woven member and a process in which the non-woven member is pressed against a mold and formed to a predetermined shape. The heating process and the process of forming to the predetermined shape may be performed simultaneously, or may be performed separately and sequentially.

The protective member 20 includes a protector main body 22, a flat support surface 24, and a positioning surface 26. The protective member 20 is formed into an outer shape corresponding to a shape of a die used in the hot-pressing of the non-woven member. Therefore, the protector main body 22, the flat support surface 24, and the positioning surface 26 can be formed by hot-pressing the non-woven member with a molding die having a die surface corresponding to a desired outer shape of the protector main body 22, the flat support surface 24, and the positioning surface 26. More specifically, in a state where the wire harness main body 12 is covered by the non-woven member by wrapping the non-woven member onto the wire harness main body 12 or the like, the protective member 20 can be formed having the outer shape formed to the predetermined shape by placing the non-woven member between die surfaces of upper and lower molding dies.

The protector main body 22 is a portion occupying a majority of a longitudinal direction of the protective member 20. Herein, the protector main body 22 is the portion of the protective member 20 other than the portion that forms the flat support surface 24. Herein, a cross-sectional shape orthogonal to the longitudinal direction of the protector main body 22 has an elliptical shape. However, the cross-sectional shape orthogonal to the longitudinal direction of the protector main body may also be circular, polygonal, and so on.

The flat support surface 24 is a planar portion formed on at least a portion of an outer circumference of the protective member 20, and is formed in a position where a fixating member 50 (described hereafter) is to be attached to the wire harness 10.

Herein, the flat support surface 24 is provided to a portion in a longitudinal direction of the protective member 20 and, more specifically, is provided to an end portion of the protective member 20. However, a flat support surface may also be formed on a longitudinal-direction middle portion of the protective member 20, or the like.

The cross-sectional shape of the protective member 20 is, as noted above, elliptical and the protective member 20 has a pair of flat surfaces 21 facing outward in a direction orthogonal to a flatness direction thereof. The flat support surface 24 is formed on one of the pair of flat surfaces 21. However, the flat support surface 24 may also be formed on a curving surface portion of the outer circumference of the protective member 20.

The positioning surface 26 is formed so as to be adjacent to the flat support surface 24 in a direction orthogonal to an axis direction of the wire harness main body 12 and so as to rise with respect to the flat support surface 24 in a direction projecting from the flat support surface.

Herein, the positioning surface 26 is formed by giving the flat support surface 24 a shape recessed further than the flat surface 21.

In other words, the flat support surface 24 is formed to be narrower than the flat surface 21 and is formed in a position further to one side of the flat surface 21. In addition, the flat support surface 24 is formed so as to recess further than the fiat surface 21. A recessed depth of the flat support surface 24 with respect to the flat surface 21 is preferably equal to or smaller than a thickness dimension of the attachment plate 52, described hereafter. In addition, a stepped portion is formed on a first side portion of the flat support surface 24 by recessing the flat support surface 24 further than the flat surface 21, and the positioning surface 26 is formed on the stepped portion so as to rise in a direction projecting with respect to the flat surface 21. Herein, an interior portion of the positioning surface 26 is partially recessed to match a shape of a side portion of the attachment plate 52, described hereafter. Moreover, the positioning surface 26 is not necessarily orthogonal with respect to the flat support surface 24 and may instead be inclined with respect to the flat support surface 24 in a range where the attachment plate 52 supported by the flat support surface 24 can be positioned. Moreover, a second side portion of the flat support surface 24 opens outwardly without mediation by a projecting stepped portion or the like.

In addition, an axis-direction positioning surface 28 is formed on a portion of the flat support surface 24 adjacent to an interior side of the wire harness main body 12 in the axis direction of the wire harness main body 12. This axis-direction positioning surface 28 is also formed so as to rise in a direction projecting from the flat surface 21 to the same degree that the flat support surface 24 is recessed beyond the flat surface 21. Moreover, the axis-direction positioning surface 28 is also not necessarily orthogonal with respect to the flat support surface 24 and may instead be inclined with respect to the flat support surface 24 in a range where the attachment plate 52 supported by the flat support surface 24 can be positioned. Further, another axis-direction end portion of the flat support surface 24 opens outwardly from the protective member 20 without mediation by a projecting stepped portion or the like.

In the above-described embodiment, by recessing the flat support surface 24 further than the flat surface 21, the positioning surface 26 and the axis-direction positioning surface 28 are formed; however, this is not necessarily required. For example, the flat support surface 24 and the flat surface 21 may be formed at the same height position, and in addition a ridge wall may be formed around a periphery of the flat support surface 24 and a positioning surface and axis-direction positioning surface may be formed by inward-facing surfaces of the wall.

The flat support surface 24, the positioning surface 26, and the axis-direction positioning surface 28 are described by relationship to the fixating member 50.

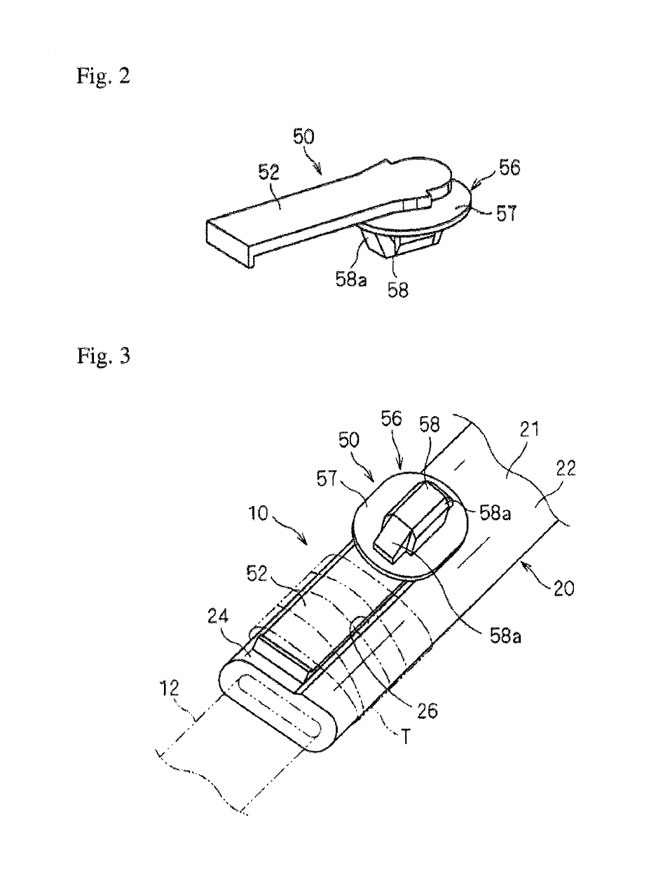

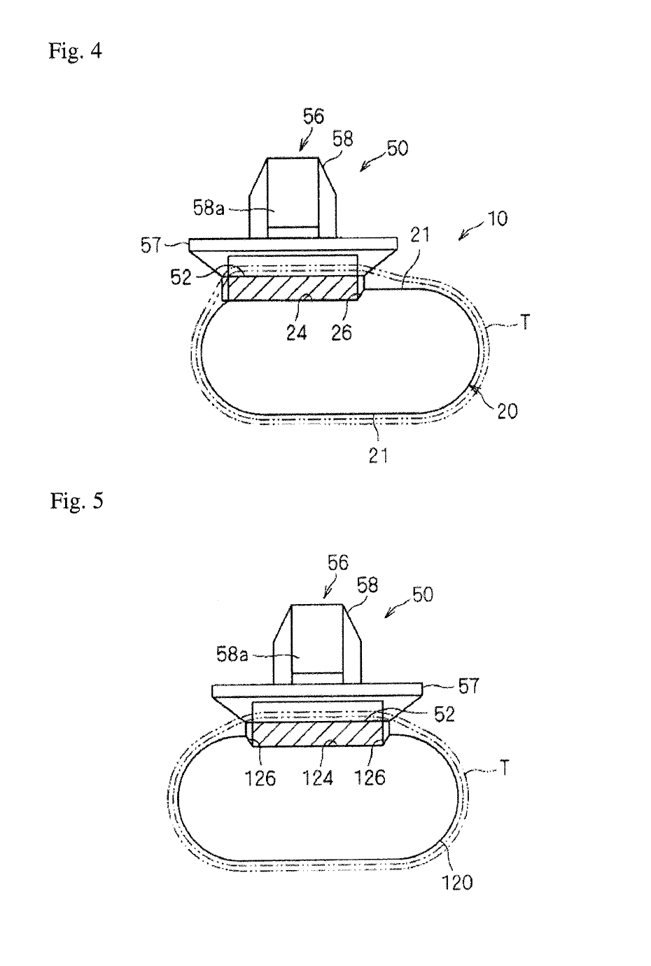

FIG. 2 is a schematic perspective view illustrating the fixating member 50 attached to the protective member 20, FIG. 3 is a schematic perspective view illustrating the fixating member 50 in a state attached to the protective member 20, and FIG. 4 is a schematic cross-sectional view of the fixating member 50 attached to the protective member 20.

The fixating member 50 includes a long, thin attachment plate 52 and a vehicle body fixation portion 56 capable of fixating to the vehicle body. The fixating member 50 is a component integrally formed of a resin and is also referred to as a sleeve clamp. In addition, a fixating member having attachment plates extending on both sides with respect to the vehicle body fixation portion is called a double sleeve clamp, while a fixating member having an attachment plate extending on only one side with respect to the vehicle body fixation portion is called a single sleeve clamp. Herein, the fixating member 50 is described using an example of the single sleeve clamp; however, the double sleeve clamp may also be used.

The attachment plate 52 is formed in a long, thin plate shape. A width of the flat support surface 24 is set to be the same as a width of the attachment plate 52. However, the width of the flat support surface 24 may also be smaller than the width of the attachment plate 52. Even in such a case, the width of the flat support surface 24 is preferably a width enabling surface contact without jostling the attachment plate 52, e.g., a width half or more than that of the attachment plate 52, Also, a length dimension of the flat support surface 24 is preferably set to be approximately equal to a length dimension of the attachment plate 52.

Moreover, a broad portion is formed on a portion closer to a first end portion of the attachment plate 52, the broad portion being (slightly) broader in width than other portions such as the middle portion, a second end portion, and so on. This portion is positioned at a partially recessed portion on the interior side portion of the positioning surface 26.

The vehicle body fixation portion 56 is integrally formed so as to project beyond a main surface of the first end portion of the attachment plate 52, and includes a dish-shaped portion 57 and an engagement lock portion 58. Thus, the attachment plate 52 extends toward one side of a head portion of the vehicle body fixation portion 56. The dish-shaped portion 57 is formed in a dish shape sequentially widening toward the engagement lock portion 58 side. The engagement lock portion 58 is a portion formed projecting in a central portion on an interior side of the dish-shaped portion 57 and has a retaining projection 58a formed in a position a predetermined distance from the dish-shaped portion 57. The retaining projection 58a is a portion capable of elastic deformation in an interior-exterior direction.

The fixating member 50 is attached and fixated to the protective member 20 in the following way.

Specifically, a second main surface (a top surface in FIGS. 2 to 4) of the attachment plate 52 is arranged along the longitudinal direction of the flat support surface 24 and brought into surface contact therewith. At this point, a first side of the attachment plate 52 is brought into contact with the positioning surface 26. Thus, a second side of the attachment plate 52 is arranged along a side edge portion of an open side of the fiat support surface 24 on a side opposite the positioning surface 26. The first end portion of the attachment plate 52 is then brought into contact with the axis-direction positioning surface 28.

In the above state, an adhesive tape T as a winding member is wrapped in a spiral form around the attachment plate 52 and the protective member 20. Thereby, the fixating member 50 is attached to the protective member 20 in a state where the second main surface of the attachment plate 52 is brought into surface contact with the flat support surface 24 and one side of the attachment plate 52 is brought into contact with the positioning surface 26.

Additionally, in the above-described state, the adhesive tape T wrapped around the outer circumference of the protective member 20 presses the second side of the attachment plate 52 toward the positioning surface 26 and, thereby, the first side of the attachment plate 52 is pressed against the positioning surface 26. Therefore, the attachment plate 52 can be attached in a more accurate position in the width direction of the flat support surface 24.

As described above, in a state where the attachment plate 52 of the fixating member 50 is attached and fixated to the protective member 20, the engagement lock 58 is pressed into an attachment hole formed on the vehicle body, bringing the dish-shaped portion 57 into contact with the vehicle body. In addition, the retaining projection 58a is retained and engaged in the attachment hole. Thus, the fixating member 50 is attached and fixated to the vehicle body. In this way, the wire harness 10 is attached to the vehicle body via the fixating member 50.

Moreover, in addition to the adhesive tape T described above, a bundling band or the like may be employed as the winding member.

According to the wire harness 10 configured as above, by attaching the fixating member 50 to the flat support surface 24, the orientation of the fixating member 50 can be made stable. More specifically, by bringing the attachment plate 52 into surface contact with the flat support surface 24, the orientation of the fixating member 50 can be made stable such that the fixating member 50 does not oscillate or shift with respect to the protective member 20.

Also, by pressing against the positioning surface 26 of the fixating member 50 (more specifically, by pressing the first side of the attachment plate 52 against the positioning surface 26), the fixating member 50 can be attached in an accurate position in a direction parallel to the flat support surface 24 and orthogonal to the axis direction of the wire harness main body 12.

As described above, as a result of the fixating member 50 being attached in a stable orientation and accurate position with respect to the protective member 20, when the fixating member 50 is attached and fixated to the vehicle body, the fixating member 50, wire harness main body 12, and protective member 20 can be accurately arranged in a location in the vehicle body where the components are to be placed and the work of placement can be readily performed. Also, the wire harness main body 12 and the protective member 20 are attached and fixated in a more accurate position and orientation with respect to the vehicle body. Therefore, concerns regarding contact between the protective member 20 or the wire harness main body 12 and the vehicle body can be effectively inhibited, such as generating noise, for example.

Moreover, the adhesive tape T or the like is wrapped around the attachment plate 52 and the protective member 20, the second side of the attachment plate 52 is pressed by the adhesive tape T or the like, and the first side of the attachment plate 52 is pressed against the positioning surface 26. Therefore, the fixating member 50 can be attached in a more accurate position in the direction orthogonal to the axis direction of the wire harness main body 12.

The second side of the attachment plate 52 projects greatly beyond the outer circumference of the protective member 20 at an edge portion of the open side of the flat support surface 24. Therefore, the attachment plate 52 can be attached and fixated so as to be pressed more effectively against the protective member 20 by the adhesive tape T.

In addition, the axis-direction positioning surface 28 is formed on the protective member 20 adjacent to the flat support surface 24 in the axis direction of the wire harness main body 12 and the attachment plate 52 is also in contact with the axis-direction positioning surface 28. Therefore, even in the axis direction of the wire harness main body 12, the fixating member 50 can be attached in a more accurate position.

Moreover, in a ease where a flat support surface is formed on a longitudinal-direction middle portion of a protective member, an axis-direction positioning surface may be provided at both longitudinal-direction ends of the flat support surface,

In addition, as in the ease of a protective member 120 shown in FIG. 5, a positioning surface 126 corresponding to the positioning surface 26 above may be provided to both sides of a flat support surface 124 corresponding to the flat support surface 24. In such a case, the flat support surface 124 is formed to the same width as the attachment plate 52. Also, in a state where the attachment plate 52 is brought into surface contact with the flat support surface 124 such that both side portions of the attachment plate 52 contact a pair of the positioning surfaces 126, by winding the adhesive tape T around the attachment plate 52 and the protective member 20, the fixating member 50 is attached to the protective member 20.

According to this variant example, both side portions of the attachment plate 52 are in contact with the pair of positioning surfaces 126. Therefore, the fixating member 50 can be attached and fixated to the protective member 20 in a more accurate position in the width direction thereof.

The present invention has been described in detail above; however, the above description is in all respects illustrative and the present invention is not limited to the above description. Numerous modifications not named as examples are understood to be conceivable without deviating from the scope of the present invention.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A wire harness comprising:
a wire harness main body; and
a protective member, the protective member being formed by hot pressing a non-woven member in a condition in which the non-woven member covers at least a portion of the wire harness main body, the protective member including a flat support surface formed on at least a portion of an outer circumference, and at least one positioning surface formed adjacent to the flat support surface in a direction orthogonal to an axis direction of the wire harness main body and extending in a direction projecting from the flat support surface.

2. The wire harness according to claim 1, wherein a fixating member including an attachment plate having a long, thin plate shape and a vehicle body fixation portion capable of fixating to a vehicle body, is attached to the protective member in a condition in which the attachment plate is in surface contact with the flat support surface and at least one side of the attachment plate is in contact with the at least one positioning surface.

3. The wire harness according to claim 2, wherein
a width of the flat support surface is equal to or smaller than a width of the attachment plate,
the attachment plate is attached to the protective member by being wound together with the protective member by a winding member, and
a second side of the attachment plate is pressed by the winding member such that a first side of the attachment plate is pressed against the at least one positioning surface.

4. The wire harness according to claim 2, wherein
the at least one positioning surface includes a pair of the positioning surfaces provided on two sides of the flat support surface, and
two sides of the attachment plate are in contact with the pair of positioning surfaces.

5. The wire harness according to claim 2, wherein at least one axis-direction positioning surface is formed on the protective member, the axis-direction positioning surface being adjacent to the flat support surface in the axis direction of the wire harness main body.

6. The wire harness according to claim 1, wherein at least one axis-direction positioning surface is formed on the protective member, the axis-direction positioning surface being adjacent to the flat support surface in the axis direction of the wire harness main body.
